(19) United States
(12) Patent Application Publication
(10) Pub. No.: US 2013/0290005 A1
(43) Pub. Date: Oct. 31, 2013

(54) SYSTEMS AND METHODS FOR INTELLIGENT CARE TRANSITIONS INFORMED BY PREDICTIVE ANALYTICS

(71) Applicants: Guy Robert Vesto, Barrington, IL (US); Eric Tod Jester, Barrington, IL (US); Mark R. Phillips, Barrington, IL (US)

(72) Inventors: Guy Robert Vesto, Barrington, IL (US); Eric Tod Jester, Barrington, IL (US); Mark R. Phillips, Barrington, IL (US)

(73) Assignee: GENERAL ELECTRIC COMPANY, Schenectady, NY (US)

(21) Appl. No.: 13/459,978

(22) Filed: Apr. 30, 2012

(51) Int. Cl. G06Q 50/22

(52) U.S. Cl. 705/2

(57) ABSTRACT

Certain examples provide systems, methods, and apparatus for patient care and care transition support. The example system includes a strategy development and simulation tool to analyze a patient care plan and transitions of care within the care plan to develop and analyze a strategy for the transitions of care within the care plan. The example system includes a discharge planning tool including predictive analytics to provide scenario-based planning and visualization to develop the care plan for patient discharge. The example system includes visual analytics to track and display progress of the patient against the care plan for the patient. The example system includes an outcome tracker to measure care plan efficacy to provide feedback for the patient care plan and future care plans.

### FIELD

The present invention generally relates to patient care plans. More specifically, the present invention relates to systems, methods, and apparatus for enhancing and improving transitions in patient care according to a patient care plan.

### BACKGROUND

Today's healthcare involves electronic data and records management. Information systems in healthcare include, for example, healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The content for a particular information system may be centrally stored or divided at a plurality of locations. Healthcare practitioners may desire to access patient information or other information at various points in a healthcare workflow. Availability of data also provides opportunities for healthcare analytics.

Nearly all Americans are cared for by business models that profit from patients' sickness rather than wellness. This has trapped care in high cost business models. Few patients are searching to “hire” healthcare providers that can do everything for everyone else. Generally, after diagnosis most patients want the medical problem fixed as effectively, affordable and conveniently as possible. Variation is a critical element in health care systems today. Quality problems are reflected in a wide variation in the use of health care services, underuse of some services, overuse of other services, and misuse of services, and an unacceptable level of errors.

In particular, professional uncertainty and scarce use of medical evidence seem to be the key elements in many problems dealing with healthcare variations. According to an investigation by Hearst Corporation, a staggering number of Americans will die (the estimated number was 200,000 in 2009) needlessly from preventable mistakes and infections every year. Even if it is difficult to establish a direct relationship between variations and errors, reducing variations by standardizing clinical processes is an effective tool to minimize the probability of medical errors. According to the Oxfords Journal, variation problems are especially critical today because the pressure to reduce healthcare costs without reducing quality in patient care has increased.

### BRIEF SUMMARY

Certain examples provide systems, methods, and apparatus for patient care and care transition support.

An example system includes a processor and a memory to store and execute instructions to provide a strategy development and simulation tool to analyze a patient care plan and transitions of care within the care plan to develop and analyze a strategy for the transitions of care within the care plan. The example system provides a discharge planning tool including predictive analytics to provide scenario-based planning and visualization to develop the care plan for patient discharge. The example system provides visual analytics to track and display progress of the patient against the care plan for the patient. The example system provides an outcome tracker to measure care plan efficacy to provide feedback for the patient care plan and future care plans.

Certain examples provide a tangible computer-readable storage medium including a set of instructions to be executed by a processor, the instructions, when executed, implementing a system. The example system includes a strategy development and simulation tool to analyze a patient care plan and transitions of care within the care plan to develop and analyze a strategy for the transitions of care within the care plan. The example system includes a discharge planning tool including predictive analytics to provide scenario-based planning and visualization to develop the care plan for patient discharge. The example system includes visual analytics to track and display progress of the patient against the care plan for the patient. The example system includes an outcome tracker to measure care plan efficacy to provide feedback for the patient care plan and future care plans.

Certain examples provide a method including analyzing, using a processor, a patient care plan and transitions of care within the care plan to develop and analyze a strategy for the transitions of care within the care plan. The example method includes providing scenario-based planning and visualization using predictive analytics to develop the care plan for patient discharge. The example method includes tracking and displaying progress of the patient against the care plan for the patient using visual analytics. The example method includes measuring care plan efficacy using an outcome tracker to provide feedback for the patient care plan and future care plans.

### BRIEF DESCRIPTION OF SEVERAL VIEWS OF THE DRAWINGS

FIG. 1 illustrates example failures in care and transitions of care.

FIG. 2 illustrates an example Intelligent Care Transitions system including a plurality of subsystems used in a care workflow and system.

FIGS. 3 and 4 illustrate examples of a care transition strategy development and simulation tool.

FIGS. 5, 6 and 7 illustrate examples of scenario and discharge planning tools.

FIG. 8 illustrates an example a dynamic care view interface providing care circles for a patient.

FIG. 9 illustrates an example view of patient care circles associated with a care plan from a provider view.

FIG. 10 illustrates an example scenario visualization interface.

FIG. 11 illustrates an example visualization of behavioral economics decisions.

FIG. 12 illustrates an example system architecture and software components to implement, provide, and support the tools, interfaces, methods, and other solutions described herein.

FIG. 13 illustrates a flow diagram for an example method and associated information flow for intelligent care transitions.

FIG. 14 is a block diagram of an example processor platform capable of implementing methods, systems, apparatus, etc., described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Potentially preventable hospital readmissions are a $30 billion annual problem in the U.S. alone. Poorly executed care transitions in general lead to quality problems and in worst cases patient deaths. Hospitals with excessive 30-day readmissions will incur penalties against Medicare payments in 2013. Certain examples provide intelligent care transitions leveraging cloud computing, predictive analytics, data intensive computing (e.g., big data) and patient controlled social graphs. A composite solution differentiates by taking a closed-loop, system-wide, proactive and novel approach to creating intelligent care transitions and collaborations with retrospective and predictive analytics guiding every step along the way.

On a daily basis, patients with continuous, complex care needs make hundreds of thousands of transitions across different sites of care. Poorly executed transitions often result in potentially preventable hospital readmissions and in worst cases result in patient death. Re-hospitalizations cost the federal health insurance system billions of dollars, and certain example help to reduce hospital readmissions.

Factors contributing to the hospital readmissions include:

an inadequate relay of medical- and care-related information by hospital discharge planners to patients, caregivers, and/or post-acute care providers;

poor patient compliance;

inadequate follow-up care from post-acute and long-term care providers; insufficient use of supportive capacity of family caregivers;

deterioration of a patient's clinical condition; and

medical errors in a hospital that may occur during an initial admission and result in illness, injury, or harm to a patient.

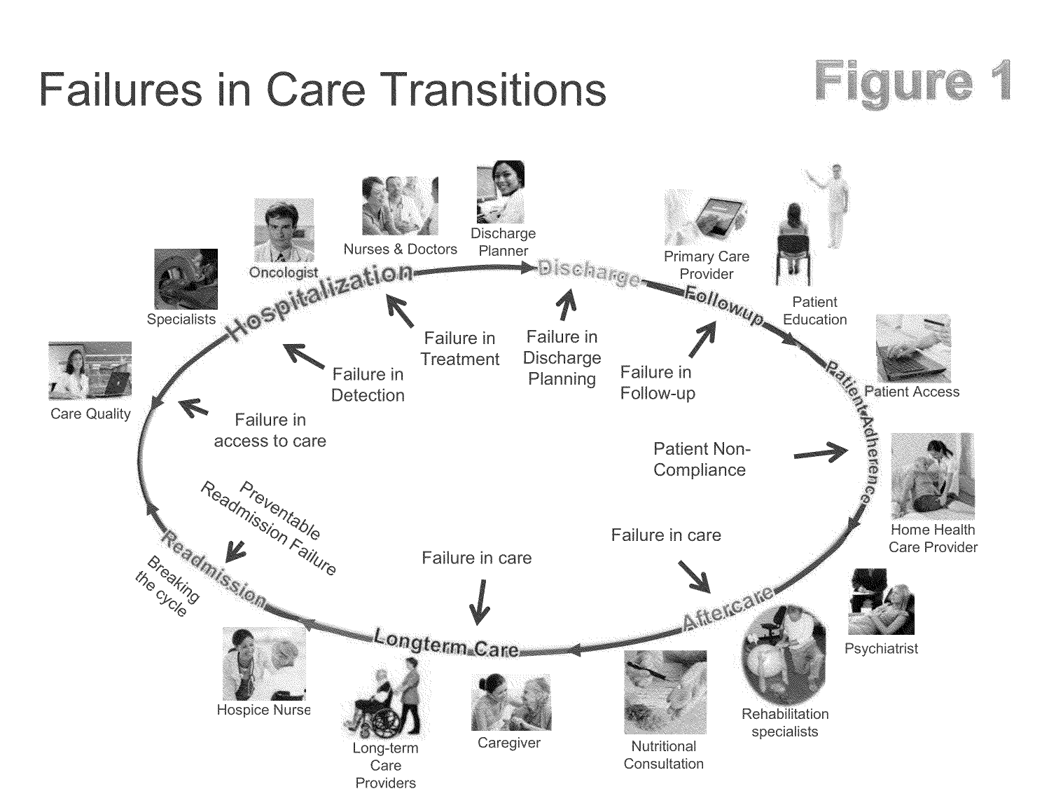

Transitional care is more complex than simple exchange of information. Although it is important for clinicians and care providers to have access to the patient's medical record, the record is not useful unless users take the initiative to read the information in the record and act accordingly. FIG. 1 illustrates example failures in care and transitions of care. As demonstrated in FIG. 1, critical information can be missed, resulting in one or more failures, such as a failure in access, failure in detection, failure in treatment, failure in discharge planning, failure in follow-up, failure in care, patient non-compliance, preventable readmission failure, etc.

Many contemporary issues in healthcare such as hospital readmissions, chronic care and bundled episodes of care suffer from a number of breakdowns including ineffective protocols, poor collaboration, a lack of visibility into the care plan, patient progress and adherence as well as ineffective patient education and engagement, for example.

Preventing breakdowns before they occur often involves a variety of challenges. In certain examples, breakdowns in care transitions can be predicted before they occur to some level of accuracy. Hospital readmission risk prediction models can incorporate clinically actionable data, for example, that can be used to triage patients to different types of interventions.

The creation of clinical pathways has become a popular response to these concerns. Clinical pathways (also known as critical pathways, care maps, integrated care pathways, etc.) are integrated management plans that display goals for patients, and provide the sequence and timing of actions necessary to achieve such goals with optimal efficiency. Clinical pathways stress the improvement of clinical processes in order to improve clinical effectiveness and efficiency. A clinical pathway is a multidisciplinary management tool based on evidence-based practice for a specific group of patients with a predictable clinical course, in which the different tasks (e.g., interventions) by professionals involved in patient care are defined, improved/optimized and sequenced by hour (e.g., for emergency department (ED)), day (e.g., acute care) or visit (e.g., homecare). Outcomes are tied to specific interventions, for example.

One or more indicators can be analyzed to determine that it may be useful to commit resources to establish and implement a clinical pathway for a particular condition. Example indicators can include prevalent pathology within the care setting, pathology with a significant risk for patients, pathology with a high cost for the hospital, predictable clinical course, pathology well defined and that permits a homogeneous care, existence of recommendations of good practices or experts opinions, unexplained variability of care, possibility of obtaining professional agreement, multidisciplinary implementation, motivation by professionals to work on a specific condition, etc.

Thus, clinical paths are clinical management tools used by health care workers to define the best process in their organization, using the best procedures and timing, to treat patients with specific diagnoses or conditions according to evidence-based medicine (EBM). As a consequence, the introduction of clinical pathways could be an effective strategy for health care organizations to reduce or at least to control their processes and clinical performance variations.

However, there are a number of challenges with implementing standardized clinical pathways in healthcare organizations. Building and developing clinical pathways may require business re-engineering techniques, involvement of multidisciplinary teams, pre and post analysis models to evaluate the effect of applying standardized pathways to process and outcome indicators.

To help ensure implementation success, patient satisfaction must also be measured along with adoption obstacles faced by care providers. In the past, finding the proper balance between clinician autonomy and standardization has proven difficult. Many doctors still consider clinical pathways as “cookbook medicine”, even though they could change the pathway for a patient at any time. Critics of clinical pathways argue that by discouraging idiosyncrasies in clinical methods, standards introduce disincentives for individual innovations in care and healthy competition among practitioners. Instead of revolutionizing care, evidence based medicine therefore threatens to bring about stagnation and bland uniformity, derogatorily characterized as “cookbook medicine.”

Furthermore, if clinicians are not involved in the definition and continuous improvement of clinical guidelines, there is a real danger that the clinical pathways could be considered an administrative attempt to reduce costs, and therefore it would most likely fail. The implementation tasks may seem daunting at first without expert assistance.

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples connect consumers (e.g., patients) to advancements in healthcare, such as in molecular medicine and clinical research relevant to their predisposed diseases (e.g., genetically, hereditarily, environmentally, etc., pre-disposed or inclined to suffer from). Furthermore, certain examples provide systems, apparatus, and methods including guidance for a user to seek professional intervention. Certain examples provide a knowledge exchange clearinghouse.

In certain examples, models that are used for risk standardization and readmission risk models intended for clinical use can provide data prior to discharge, discriminate high- from low-risk patients, and can be adapted to the settings and populations in which they are to be used. For example, marginally housed patients or those struggling with substance abuse might require unique discharge services. In certain examples, there is not a one-size fits all intervention strategy.

Certain examples provide better care plans and flexible intervention strategies. Root causes of breakdowns in care transitions vary greatly across the patient population. Patient adherence can be a factor. Examples of barriers to patient adherence are:

1.) Logistical barriers—cost, adverse effects, poor access to medicine, etc.

2.) Perceptual barriers—poor understanding of therapy, lack of belief in therapy, unable to see benefits of drug therapy, etc.

3.) Physical and mental barriers—cognitive/memory deficits, visual deficits, mental deficits, physical deficits

4.) Social barriers—poor communication with healthcare providers, patient dissatisfaction with care, language deficits, poor literacy, cultural/religious beliefs, lack of social/family support, disruption of daily routine and attitude

In certain examples, overcoming these barriers involves individualized care transition strategies and patient specific care plans. However, creating such plans can overburden hospital discharge planners. Medicare regulations in the United States require participating hospitals to have a discharge planning process that applies to all patients. Hospital discharge planning can include instructions hospitals provide to patients, caregivers, outpatient physicians, and other post-acute providers. Discharge planning can also include counselling for patients and caregivers to ensure the smooth and timely transition of a patient from the inpatient setting to a home, post-acute care setting or long-term care setting. Despite these requirements, discharge planning is often incomplete and necessary information is not provided by hospitals to physicians and post-acute providers in a timely manner. For example, timely and comprehensive delivery of discharge information from hospitals to post-acute and long-term-care providers can be a first step in breaking the cycle of unnecessary readmissions. Encouraging better collaboration among providers and enhancing accountability for patient outcomes and treatment costs can be another step.

Caregivers (e.g., family and friends who give care without compensation) play a significant role in the hospital discharge of Medicare beneficiaries. Caregivers help patients comply with their care plans, including taking and accompanying patients to follow-up physician visits and diagnostic test appointments, as well as reminding patients to take their prescribed medications and understanding or interpreting worsening medical symptoms. Training of caregivers enhances the quality of the assistance that they provide to patients thus could help reduce readmissions. Training, coaching, counselling, and education can be provided to caregivers throughout the discharge process (e.g., by hospital discharge planners by transitional care teams, etc.).

Certain examples provide “Intelligent Care Transitions” (ICT) using a system-wide approach to solving problems in care transitions and hospital readmissions. The ICT solution leverages emerging technologies including cloud computing, predictive analytics, “data intensive computing” (e.g., Big Data), social graphs, etc., and includes a set of novel components orchestrated in a closed loop system that operates in a self-reinforcing virtuous cycle.

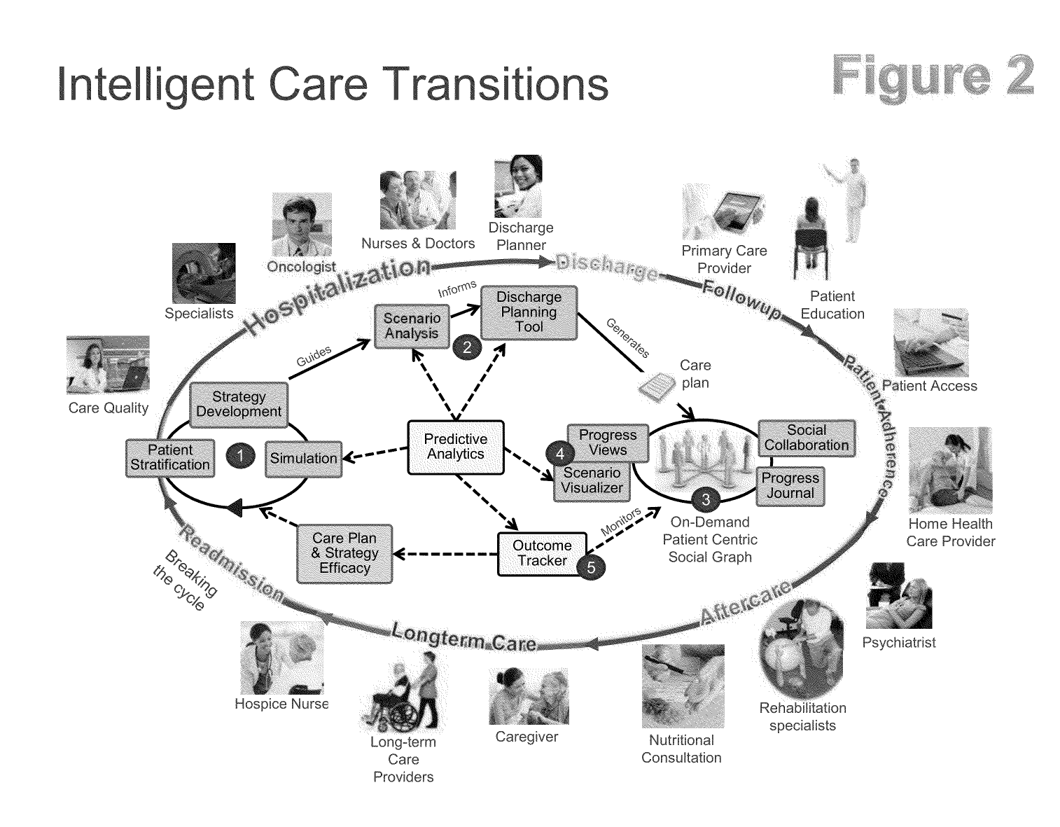

FIG. 2 illustrates an example ICT system 200 including a plurality of subsystems used in a care workflow and system. The ICT system 200 includes a care transition strategy development and simulation tool 1, a scenario and discharge planning tool 2, an on-demand dynamic care circle 3, scenario-based visual analytics 4, and an outcome tracker 5, for example.

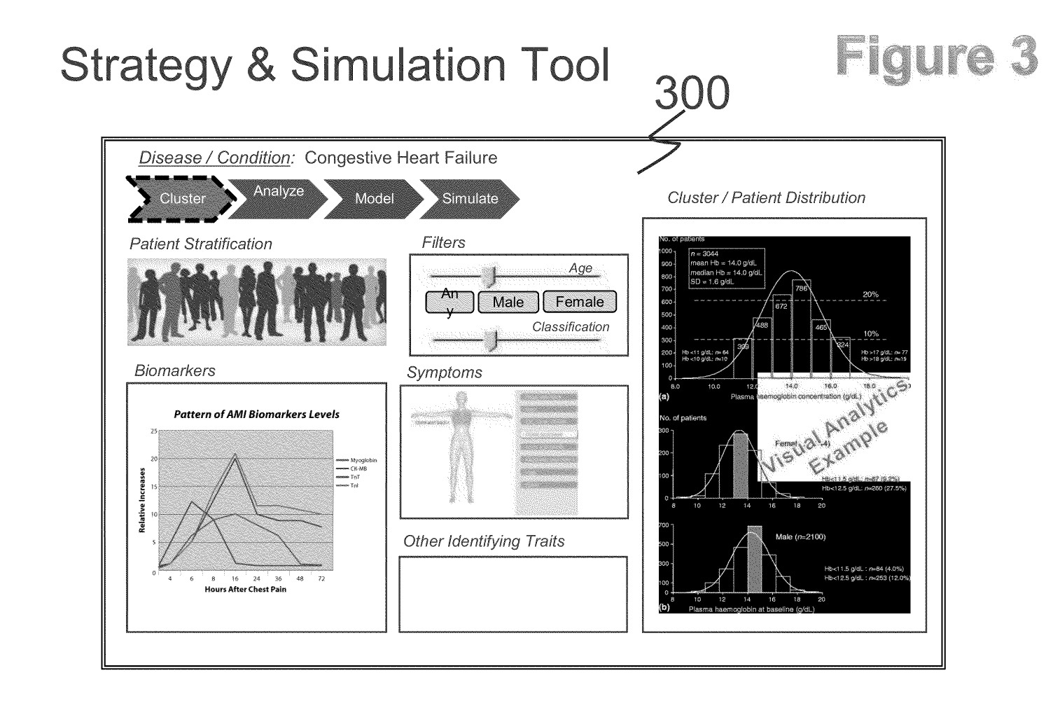

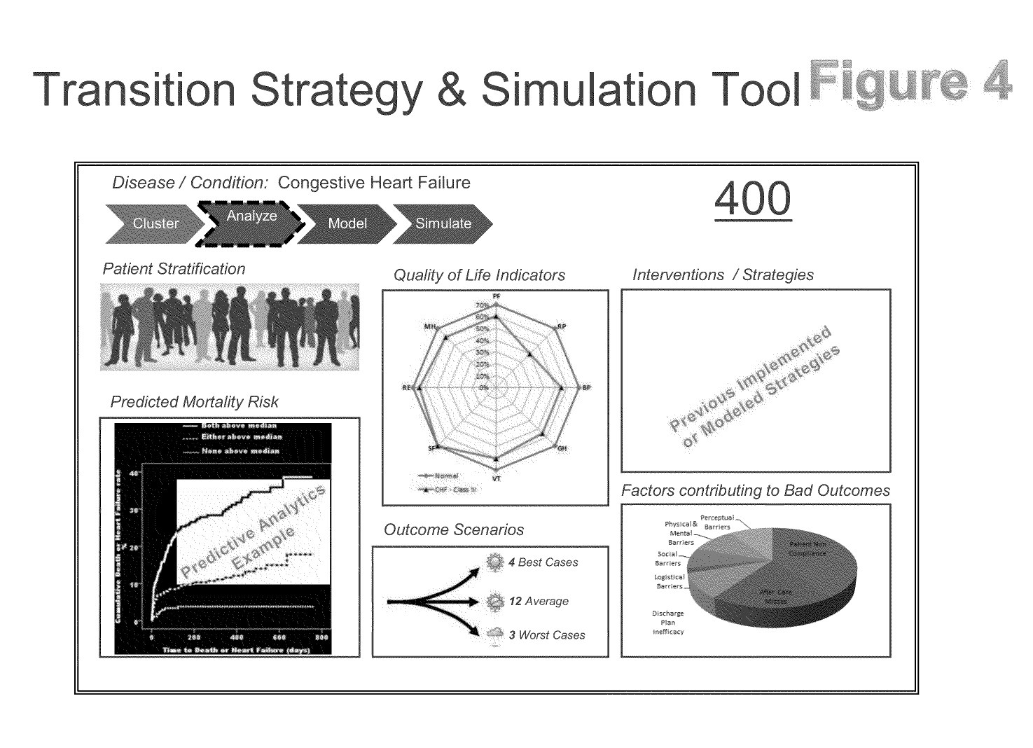

The Care Transition Strategy Development and Simulation Tool 1 facilitates patient stratification, testing of what-if scenarios, development and simulation of care transition strategies, etc. Example strategies are (but are not limited to) specific care transition interventions, family care giver education, home based primary care, home telehealth, programs for stimulating patient compliance, etc. Examples of the care transition strategy development and simulation tool 1 are illustrated in FIGS. 3 and 4.

For example, as shown in FIG. 3, a user can navigate through clustering, analysis, modeling and simulation for a disease or condition. A tool interface 300 provides information and resources such as patient stratification, biomarkers, symptoms, other identifying traits, etc., and allows a user to provide information and set filters, etc., to cluster patient information. Graphical and/or other data regarding patient distribution, clustering, etc., can be provided via the interface 300, allowing a user to develop a treatment strategy for a patient or group of patients, for example.

The example strategy and simulation tool interface 400 provided in FIG. 4 allows a user to navigate through clustering, analysis, modeling and simulation for a disease/condition (e.g., congestive heart failure). The interface 400 provides information and resources such as patient stratification, predicted mortality risk, quality of life indicators, outcome scenarios, factors contributing to bad outcomes, etc. The interface 400 provides intervention(s) and/or other strategy(-ies) for user review and selection, allowing a user to analyze an intervention/treatment strategy for a patient or group of patients, for example.

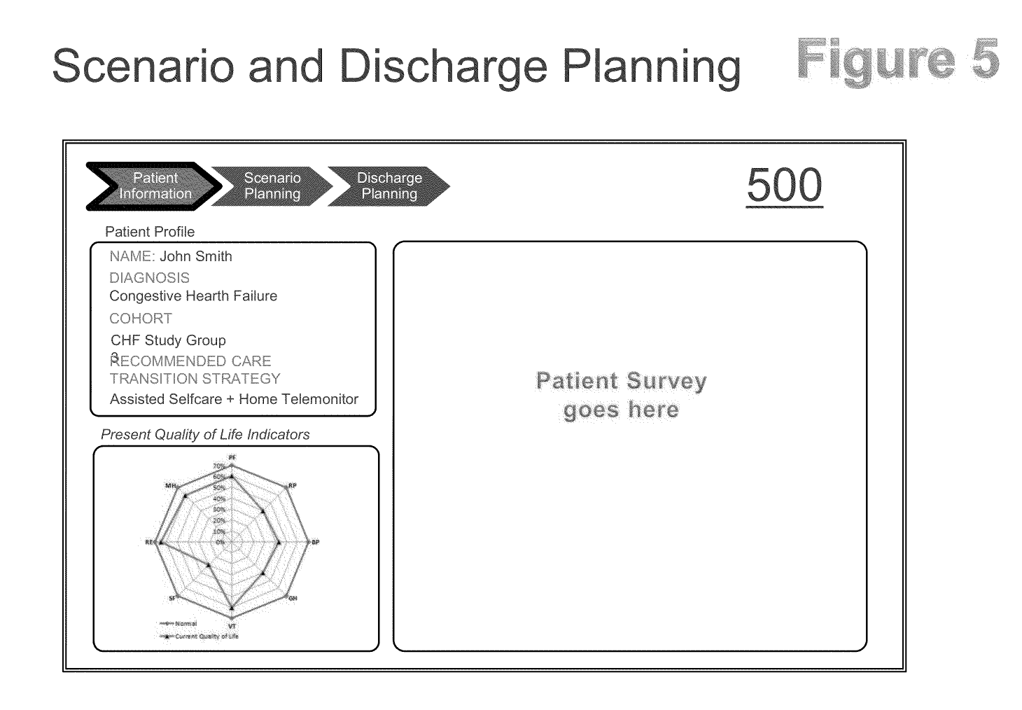

The Scenario and Discharge Planning Tool(s) 2 are driven by predictive analytics are used to inform discharge planning with a number of variables such as diagnosis, demographics and socio-economic variables. A scenario-based planning and visualization technique (e.g., best case, worst case and likely scenarios) assists in developing effective and adaptive care plans. Examples of the scenario and discharge planning tool(s) 2 are illustrated in FIGS. 5, 6, and 7.

For example, as shown in FIG. 5, a user can navigate through patient information, scenario planning, and discharge planning via an interface 500. For example, predictive analytics algorithms identify a patient as a potential preventable readmission candidate along with an associated intervention strategy recommended for that patient. In addition to a patient profile, present quality of life indicators can be provided in conjunction with a patient survey used to determine a risk profile and an optimal or otherwise recommended or suggested care plan for that patient.

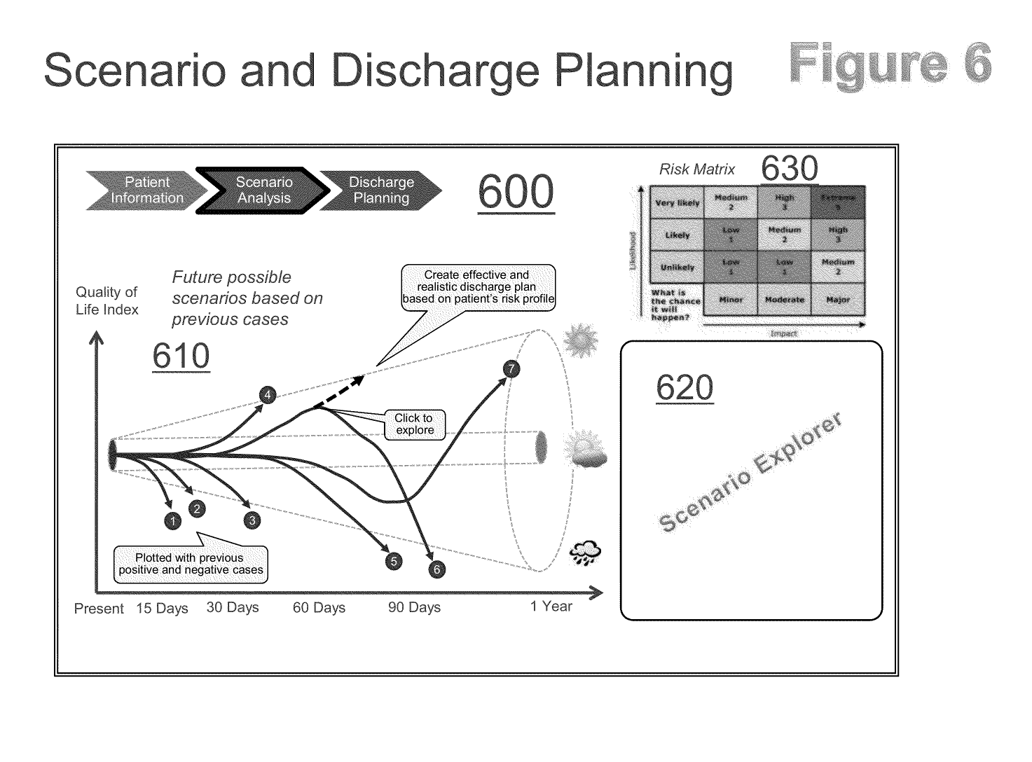

As shown the example of FIG. 6, an interface 600 provides information and facilitates scenario analysis and discharge planning for a patient. The example scenario analysis interface 600 provides information to a user, such as a clinician, a patient, etc., regarding possible future scenarios 610 based on prior case information, for example. Previous positive and negative cases over a past period of time are plotted against a quality of life index to help create at least one effective and realistic discharge plan based on a patient's risk profile. A user can click on or otherwise select a possible scenario to further explore that scenario in detail in a scenario explorer 620 provided via the interface 600, for example. A risk matrix 630 provides an indication of a likelihood or chance of an event happening for a patient and a potential or likely impact of that event if it occurs, for example.

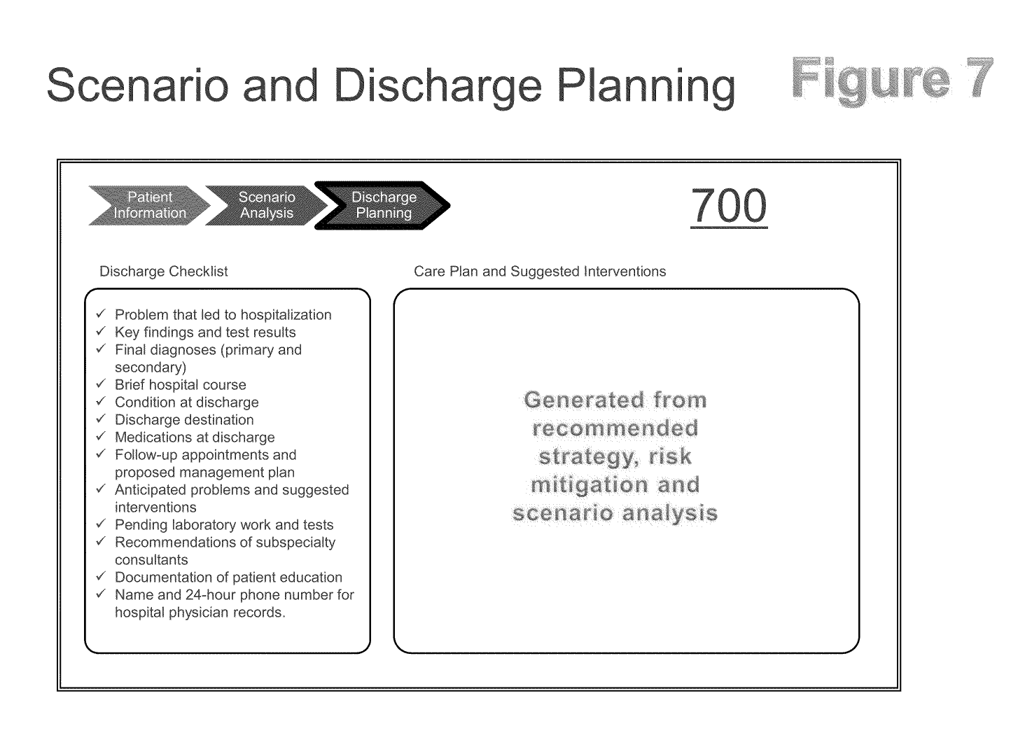

The example of FIG. 7 provides a discharge planning interface 700 which generates and displays a discharge checklist, as well as a care plan and/or suggested intervention(s) for a patient or group of patients based on a selected or automatically generated course of action. For example, the discharge planning interface 700 can provide a care plan and/or suggested intervention(s) generated from a recommended strategy, risk mitigation, scenario analysis, etc. The user can review, modify, approve, and/or print (or otherwise transmit, save, etc.) the discharge instructions based on the interface 700, for example.

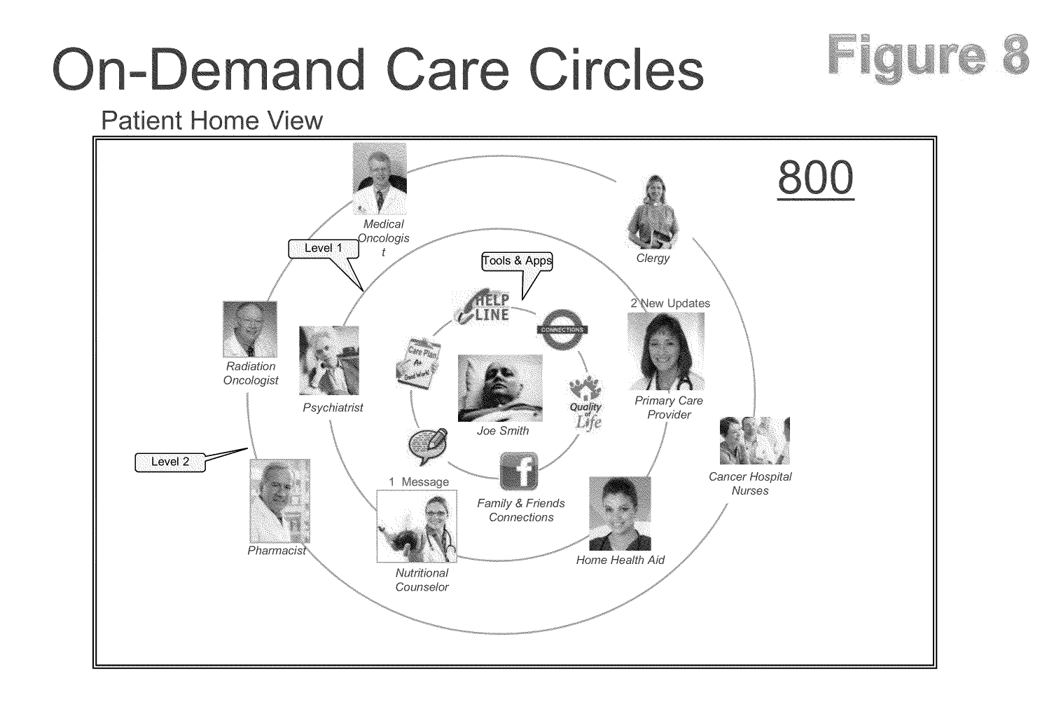

On-Demand Dynamic Care Circles 3 connects care providers and patients in a manner to help enable superior care transitions and collaboration. As shown in the example of FIG. 8, a dynamic care view interface 800, such as a patient home view, a plurality of care circles are visualized for a patient. The example of FIG. 8 provides two levels (Level 1 and Level 2) of care circles as well as tools and other applications for use by a patient to help monitor, facilitate, and/or maintain care. Level 1 and Level 2 circles change as the patient is admitted, discharged, referred, etc. The circles can spotlight care providers who are currently potentially in a position to positively affect the patient's outcome. The tools and applications can provide resources such as a connection to a help line, care plan and associated evaluation/progress, messaging, family and friends connections, quality of life indicators, available connections, etc. Level 1 provides care providers such as a primary care provider, psychiatrist, nutritional counselor, home health aide, etc. Level 2 provides care providers such as a radiation oncologist, medical oncologist, nurse, pharmacist, clergy, etc. Thus, the patient view 800 provides a patient-controlled, on-demand social graph 800 of providers and care givers, including uncompensated care givers such as family members.

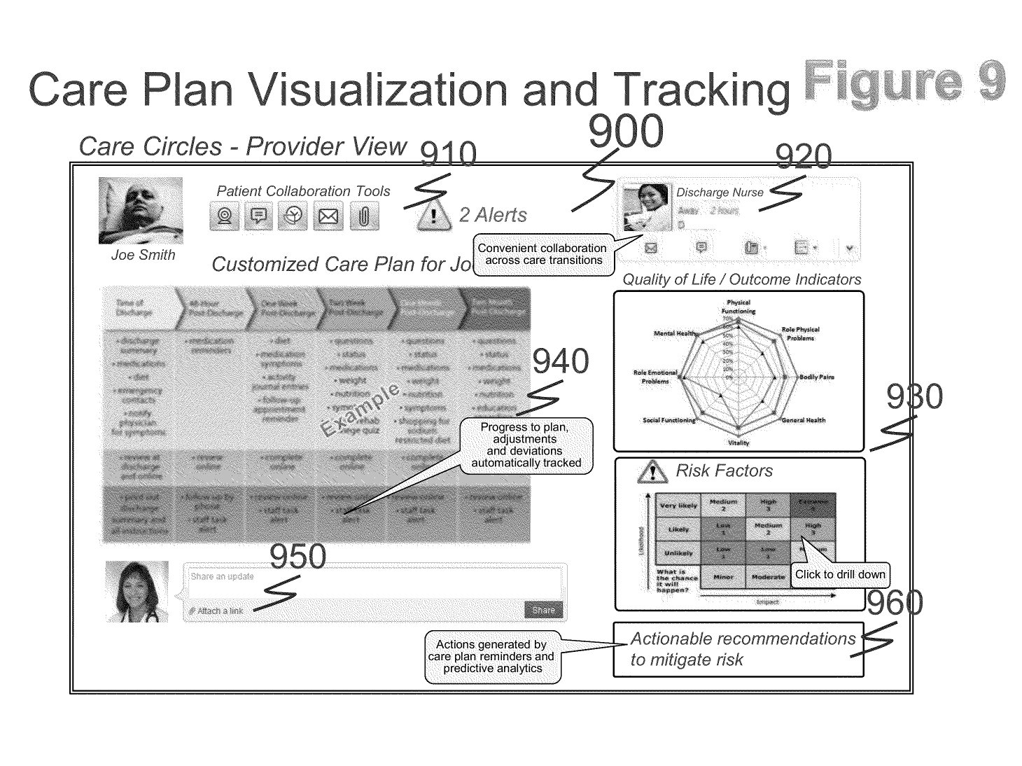

FIG. 9 illustrates an example view of patient care circles associated with a care plan from a provider view 900. The care plan is transparently published and visualized via the view 900 for a patient controlled on-demand social graph of providers and care givers, for example. The example interface 900 provides one or more patient collaboration tools and alerts 910 for the identified patient (e.g., Joe Smith). Via the interface 900, a user (e.g., the patient, clinician, etc.) can collaborate 920 with another provider across care transitions, for example. Information 930 such as quality of life/outcome indicators, risk factors, etc., can be provided via the interface 900, and the user can click or otherwise select to drill down and access further information/functionality associated with the displayed information (e.g., underlying data supporting a risk factor, outcome indicator, etc.). A customized care plan 940 for the patient is displayed via the interface 900, and progress to plan, adjustment, deviation, etc., are automatically tracked with respect to the plan 940 via the interface 900, for example. Updates can be shared with another provider 950 via the interface 900. One or more actions or actionable recommendations 960 generated by care plan reminders and predictive analytics to mitigate risk can also be displayed via the interface 900, for example.

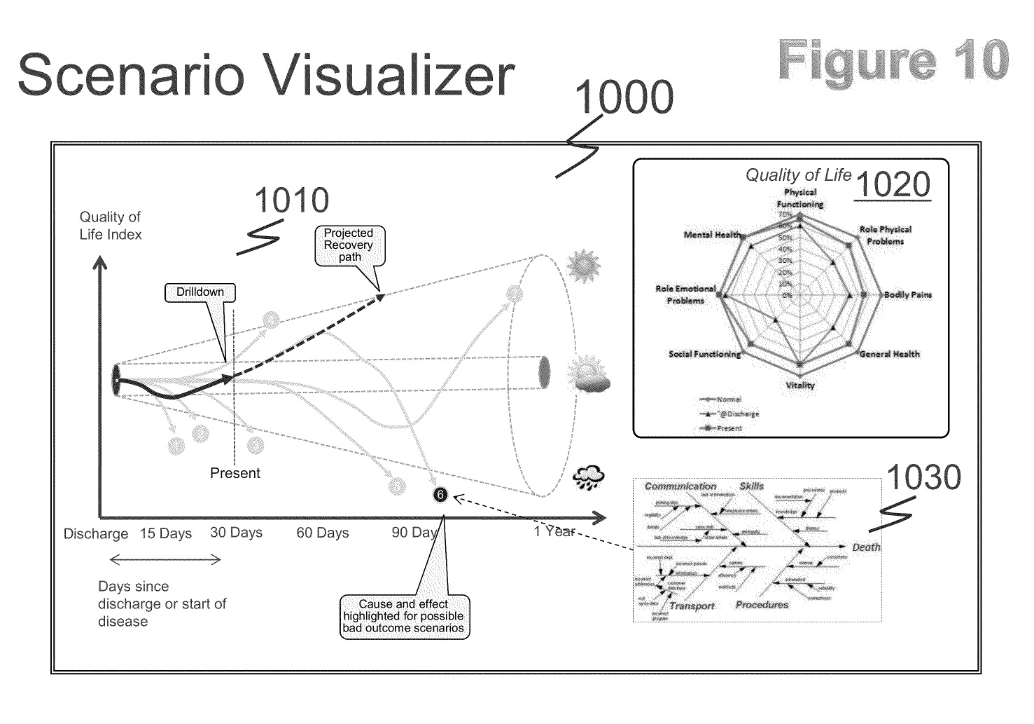

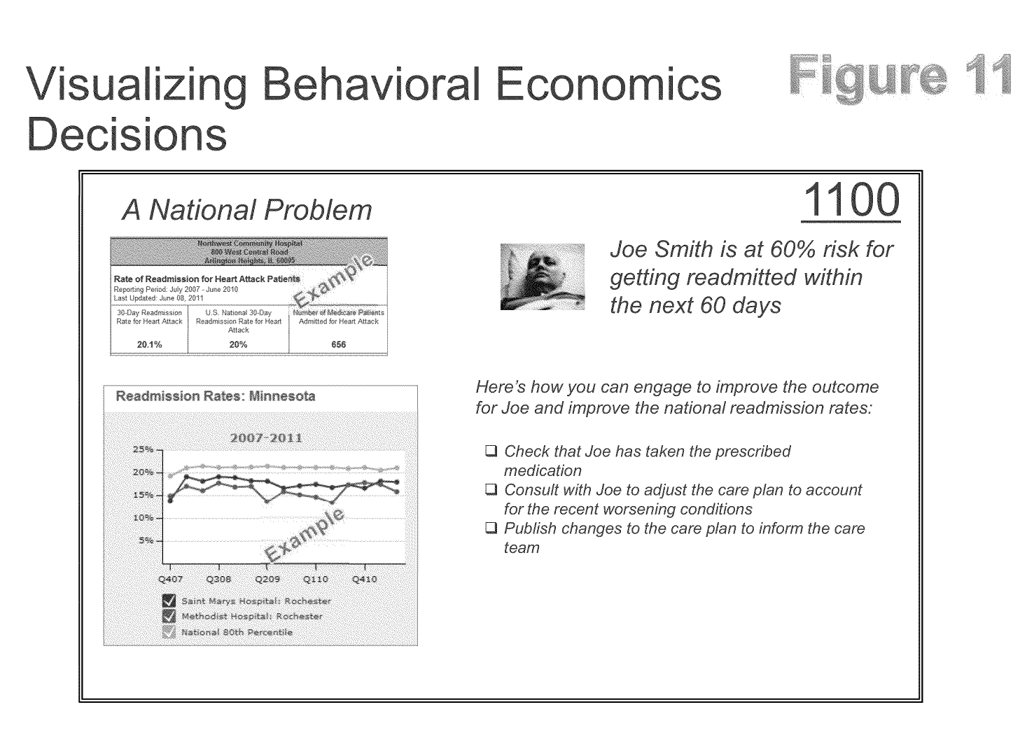

Scenario-based visual analytics 4 shows progress against a care plan, for example. Adherence is visualized with updated scenario-based visualization that clearly shows when care is on course or off course, for example. FIG. 10 provides an example scenario visualizer 1000. Visual analytics are used to measure an impact of behavioral economics based decision making on the plan of care and the adherence to the plan of care, for example. FIG. 11 illustrates an example visualization of behavioral economics decisions.

As shown in the example scenario visualizer 1000 of FIG. 10, cause and effect can be highlighted for possible bad outcome scenarios based on a graph 1010 of path based on a number of days since discharge or start of disease versus a quality of life index. The interface 1000 can provide additional detail regarding the patient's quality of life 1020 based on normal, at discharge, and present information for the patient and/or based on past information for similar patients following the same path of care. A projected recovery path on the scenario graph 1010 can be selected for further information or drill down, such as communication, skills, transport, and procedures leading to a negative outcome (e.g., death) 1030.

FIG. 11 illustrates a visualization interface 1100 providing visual analytics content published out to a care community by quality and plan administrators to influence behavior of care providers, for example. A regional or national problem, such as a rate of readmission for heart attack patients, can be provided as well as further detail for a local area (e.g., a state of residence for the patient or group of patients in question). Using available date, a likelihood of risk can be determined and displayed to the user via the interface 1100 (e.g., a likelihood of the patient getting readmitted within a certain time period). The interface 1100 can provide recommendations for a care provider and/or the patient to engage to improve an outcome for the patient, for example.

In certain examples, an outcome tracker measures care plan efficacy for application to similar scenarios and patients to continually reinforce effective plans and interventions as well as to incorporate deviations from plan with positive outcomes, for example.

The following is a detailed scenario presented for purposes of illustration only. This scenario involving care of a cancer patient is but one of many examples that will be clear to one of ordinary skill in the art after reading and understanding the description above. However, for brevity, the following example is provided.

Example Scenario—Cancer Patient Care

The example scenario is for a cancer patient who lives in a rural area of the country. The patient is a 29 year old male and father of two young sons who has just been diagnosed with Acute Lymphocytic Leukemia (ALL). To begin his treatment, he must travel one hour by flight to the nearest cancer hospital. Prior to his arrival at the hospital, a Chief Quality Officer at the hospital has just completed some patient stratification and analysis of Leukemia patients. Using the stratification tool 300 (see FIG. 3), he can determine that rural cancer patients often end up travelling to another regional cancer center for bone marrow transplants. The retrospective analytics provided by the strategy and simulation tool (see FIG. 4) gives him a deeper insight. Care transitions can be numerous along the way with home care providers playing a critical role in the overall patient outcome. The provider also discovers that rural patients, being around livestock, have a high risk for infections and often end up getting readmitted for treatment of infections. Additionally, he discovers a case that resulted in a patient's death. Root cause analysis showed that one of the care transitions was poorly executed. The patient did not receive the medicine which could have prevented pulmonary aspergilloma (lung fungus) from developing. The bone marrow transplant had weakened the patient's immune system which resulted in his death. Better care coordination between the two participating cancer hospitals is an imperative.

Armed with this knowledge, the Chief Quality Officer can design an intervention strategy to improve the situation for rural cancer patients (see FIG. 4). Using the built-in simulation tool, he determines that the hospital readmission rates can be dramatically reduced for his hospital with associated cost savings.

When the ALS cancer patient is admitted at the hospital to begin a first phase of the treatments he brings a mobile computer to keep in touch with his family and friends using, for example, Facebook™ and Skype™. He is pleased to discover the “On-Demand Care Circles” social application 800 (see FIG. 8) which allows him to connect with his cancer care team. This application 800 empowers him to ask questions of any of the care team members and get quick answers as he may feel anxious over the upcoming treatments. Meanwhile, a friend of his has created a dedicated cancer social support group for him on Facebook™. Linking the two applications, the patient can relay up-to-date information from the care providers to his friends and families at his own discretion. Thus, the patient feels like he has some control over the situation.

As he completes the first phase of the treatment, a discharge nurse walks the patient through the discharge planning process. The predictive analytics built into the discharge planning tool 500 (see FIG. 5) identifies that he is part of a new study group under the supervision of the Chief Quality Officer. After answering some questions from the discharge nurse (e.g., generated by the tool 500), the patient and the nurse together are able to examine some future possible scenarios provided by the analytics engine 600 (see FIG. 6). Initially, the patient may be bothered that he could so easily get readmitted within less than 15 days, but the patient feels more empowered by the new knowledge. The discharge nurse examines a root cause of the scenario which had resulted in a fatality and studied the recommendations for how to reduce the risk score for the patient. Using the scenario and discharge planning interface 700, a care plan can be developed (see FIG. 7). At this point, the nurse accepts the intervention recommendation provided by the tool 700 and makes some minor adjustments to the discharge plan after consulting with the patient and his insurance provider. At the time the patient is discharged, a Primary Care Provider (PCP) is automatically notified and is able to view the care plan by logging into the “Care Circles” application 800, 900 (see FIG. 8 and FIG. 9).

After coming home, the patient logs into the “Care Circles” application 800 and is pleased to discover that the application is aware of his discharge status, and the care circles have automatically expanded to include his home care team and the primary doctor. He grants the home care team members access to his electronic medical record and activates the collaboration features. A message from his primary doctor welcomes him home and suggests some dates for him to come in for a visit. He accepts the appointment request. When arriving for his first appointment, the doctor tells him that he talked with the discharge nurse to clarify the care plan (see FIG. 9.). Together, they review some educational collateral that had been published into the application and begin to discuss possible donor matches for a future bone marrow transplant.

A few months later after completing phase II of the treatment back at the cancer hospital, the patient and the discharge nurse review his progress using the “scenario visualizer” 1000 (see FIG. 10). This tool 1000 is available to everyone using the “Care Circles” application 800, 900, for example. They conclude that care is progressing according to plan. However, a critical decision point awaits the patient: whether or not to proceed with the bone marrow transplant. This would require him to transfer to the regional cancer hospital and he is very uncomfortable with having to change his cancer care team. Meanwhile, his brother has been confirmed as a matched donor for the bone marrow transplant. Again, the “Care Circles” application 800, 900 is an invaluable tool which enabled him to consult with his entire cancer care team about the risks of the bone marrow transplant. It is his decision, but he becomes convinced the transplant is the right next step. It is a very tough and testing phase in his cancer journey.

After being admitted at the second (e.g., regional) cancer hospital, the patient logs into the “Care Circles” application 800 and is again pleased to discover the new faces that had been added to his cancer team (see FIG. 8.) He receives welcoming messages and encouragement from each of them. They have reviewed and updated his care plan via interface 900. The bone marrow transplant proceeds smoothly. After some weeks, he is again discharged and sent back home. Another follow-up visit is scheduled with the primary care provider. The doctor reviews the updated scenario visualizer 1000 (see FIG. 10) and checks to make sure that the patient has received all necessary medications. The “bone marrow” transplant procedure has wiped out his childhood immunizations. Thus, a very challenging recovery period awaits the patient. At this point, the primary care doctor discovers that the patient had been approved for an intervention (originally designed by the Chief Quality Officer team back at hospital 1). A home care aid will come to the patient's home every other day to care for the patient during this critical period. Today, the patient is a cancer survivor and numerous preventable hospital readmissions have been eliminated.

Thus, certain examples can help navigate through a plurality of care transitions including: 1) prior to arrival for treatment, 2) enhanced discharge planning process, 3) primary care provider follow-up, 4) transfer to specialty hospital, 5) discharge from specialty procedure, 6) post-discharge follow-up and intervention, etc.

The above scenario is a complex case. There are numerous other scenarios which can be described and where the systems and associated methods described above and illustrated in the drawings play an important role in improving the patient outcome.

System Architecture

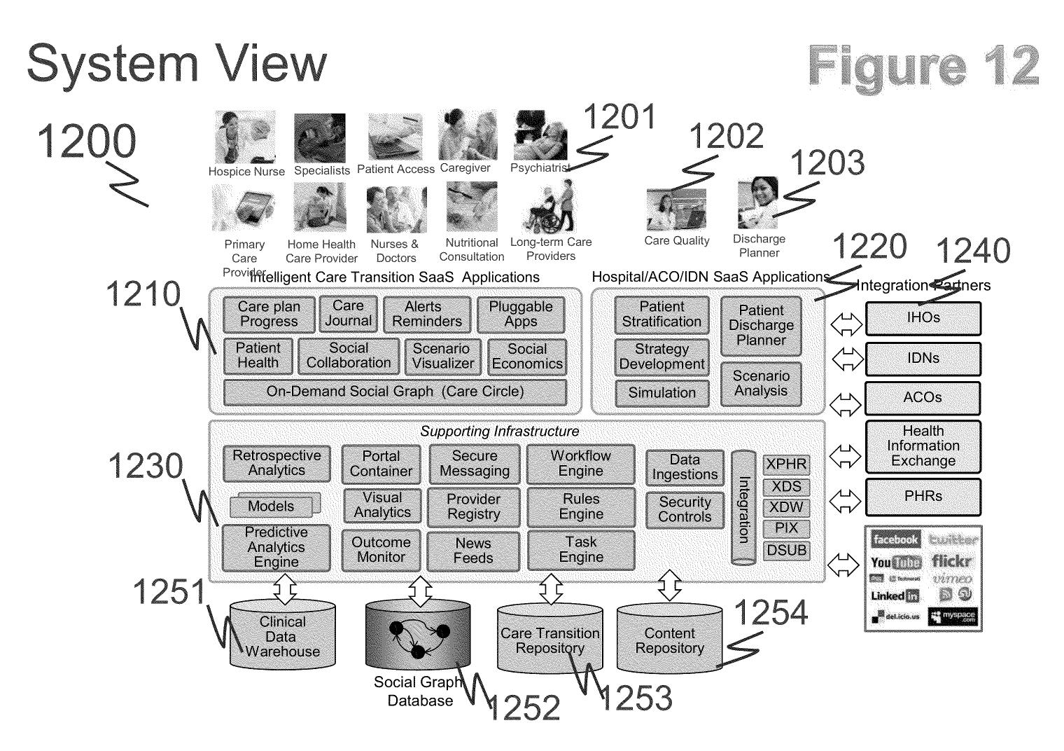

An example system architecture and components 1200 to implement, provide, and support the tools, interfaces, methods, and other solutions described above is shown in FIG. 12. The system 1200 can be deployed as a cloud-based solution, for example, to take advantage of cost effectiveness and scalability provided by cloud providers as well as an ability to leverage collective intelligence, models, intervention strategies, etc., across multiple healthcare organizations. Some or all of the system 1200 can also be integrated with Health Information Exchanges, Population Health Management solutions, Personal Health Record solutions, patient portals, social networks, etc.

The example system 1200 includes one or more connections to and/or indications of care participants 1201 (e.g., hospice nurse, specialist, patient access, caregiver, psychiatrist, primary care provider, home health care provider, nurse, doctor, nutritional consultation, long-term care provider, etc.). Care participant(s) 1201 (e.g., the patient and/or care provider) can access functionality provided by the system 1200 via a software-as-a-service (SaaS) implementation over a cloud or other computer network, for example. While SaaS is described herein for purposes of illustration, all or part of the system 1200 can also be provided via platform as a service (PaaS), infrastructure as a service (IaaS), etc. Other personnel, such as a care quality analyst 1202, discharge planner 1203, etc., can be connected to and/or otherwise utilize the system 1200 as well, for example.

One or more intelligent care transitions applications 1210 can be provided as part of the system 1200 via SaaS, for example. Additionally provider analysis applications 1220 such as hospital applications, accountable care organization (ACO) applications, integrated delivery network (IDN) applications, etc., can be provided as part of the system 1200 via SaaS, for example. Intelligent care transition applications/components 1210 can include one or more of care plan progress, care journal, alerts/reminders, pluggable applications, patient health information/monitor, social collaboration, scenario visualizer, social economics, on-demand social graph (e.g., care circle), etc., as described above, for example. Other care provider applications/components 1220 can include one or more of patient stratification, strategy development, simulation, patient discharge planner, scenario analysis, etc., as described above, for example.

Applications 1210, 1220 and/or other functionality can leverage a supporting infrastructure 1230. The supporting infrastructure 1230 includes one or more of retrospective analytics, a portal container, a workflow engine, data ingestions, one or more data and/or plan models, visual analytics, provider registry, rules engine, security controls, predictive analytics engine, outcome monitor, news feed, task engine, etc.

Retrospective analytics provides a historic cohort study and a type of medical research to look back at events that have already happened, for example. The predictive analytics engine provides machine learning to analyze current and historical events to predict future events such as potentially preventable hospital readmissions, for example. The portal container provides a Web portal to support pluggable user interface components, for example. Visual analytics tools provide analytical reasoning facilitated by interactive visual interfaces, for example. Visual analytics tools can be used to identify alternative futures and their warning signs, for example. The outcome monitor provides a surveillance engine to track a patient's treatment progress and deviations against a care plan, for example. Secure messages provides a secure collaboration infrastructure to support peer consults, patient collaboration, telemedicine and second opinions, for example. The provider registry includes a registry of healthcare providers that can be added to the patient's care circle, for example. The news feed engine delivers a social news feed into the care circle application, for example. The workflow engine provides a process orchestration engine to automate care transition processes and care plan activities, for example. The rules engine executes business rules in a runtime production environment, for example. For example, the rules engine executes business rules when interventions are mandated. The task engine manages human workflows, tasks, and escalations, for example.

The supporting infrastructure 120 includes integration with one or more partners, standards, etc. 1240, such as one or more integrated healthcare organizations (IHOs), IDNs, ACOs, health information exchanges (HIEs), personal health records (PHRs), electronic medical records (EMRs), social networks (e.g., Facebook™, twitter™ YouTube™, flickr™, digg™, Technorati™, LinkedIn™, del.icio.us™, myspace™, RSS, etc. Integration can be facilitated via one or more of Integrating the Healthcare Enterprise (IHE) profile including Exchange of Personal Health Record Content (XPHR), Cross-enterprise Document Sharing (XDS), Cross-enterprise Document Workflow (XDW), Patient Identifier Cross Referencing (PIX), Document Metadata Subscription (DSUB), etc.

The supporting infrastructure 1230 shown in the example of FIG. 12 leverages one or more data stores, such as a clinical data warehouse 1251, social graph database 1252, care transition repository 1253, content repository 1254, etc.

Reimbursement trends such as the Medicare 30-day excessive readmission penalty, value-based purchasing rewards to high quality providers and other payment innovations alter traditional business models and place a premium on cost effectiveness and care coordination. Healthcare is experiencing a marked shift from a fee for service model that incents individual episodes of care to an integrated model with various forms of payment bundling all the way up to capitation. A shift can be made towards a model that incents and provides the capability to coordinate care and care transitions. Certain examples help healthcare organizations to measure the effectiveness of interventions and understand expected outcomes with an eye towards modeling financial risk. There are many economic buyers participating in this shift including Accountable Care Organizations, Integrated Healthcare Organizations, Integrated Delivery Networks, Group Purchasing Organizations, Payers, Self-Insured Employers, and Governments.

Thus, certain examples provide a system-wide approach to the problem, focuses on the clinical workflows and the root causes of care transition failures. Certain examples empower patients, caregivers, care providers and envisions integrated care models where the providers are encouraged to collaborate to enhance accountability for patient outcomes and treatment costs.

Certain examples allow for a variety of prediction models whose effectiveness is continuously evaluated through a closed loop feedback model. Certain examples provide predictive analytics throughout care transitions in a care plan or pathway. Certain examples provide an integrated scenario analysis tool including discharge planning Certain examples provide an “on-demand” social graph (care circles) adapted and optimized for care plan collaboration. Certain examples provide use of “behavioral economics” concepts to influence care providers and nudge a patient into adherence. Certain examples utilize integrated patient stratification, strategy planning and simulation. Certain examples provide visual analytics, such as a “scenario visualizer”.

In certain examples, in place of or in addition to a cloud or network-based solution, “smart cards” can be used to allow patients to carry data from provider to provider. Password-protected, web-based medical records can be provided to make the information available on a need-to-know basis. Patients can be equipped with hand-held personal data assistants, smart phones, etc., to convey information across care settings.

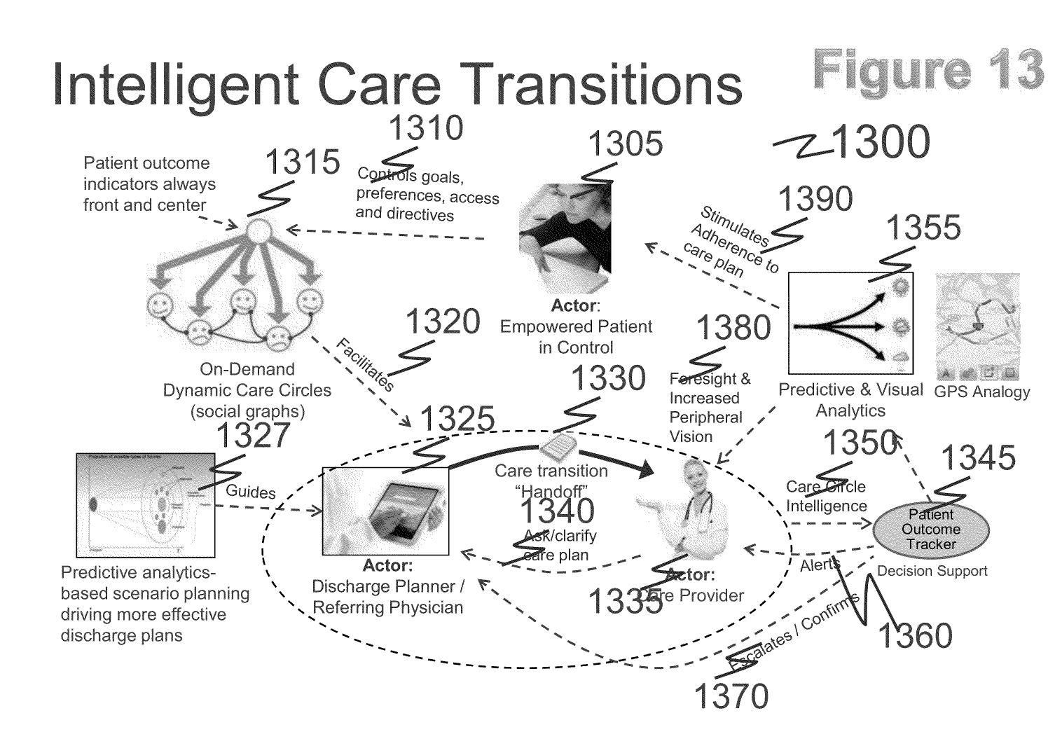

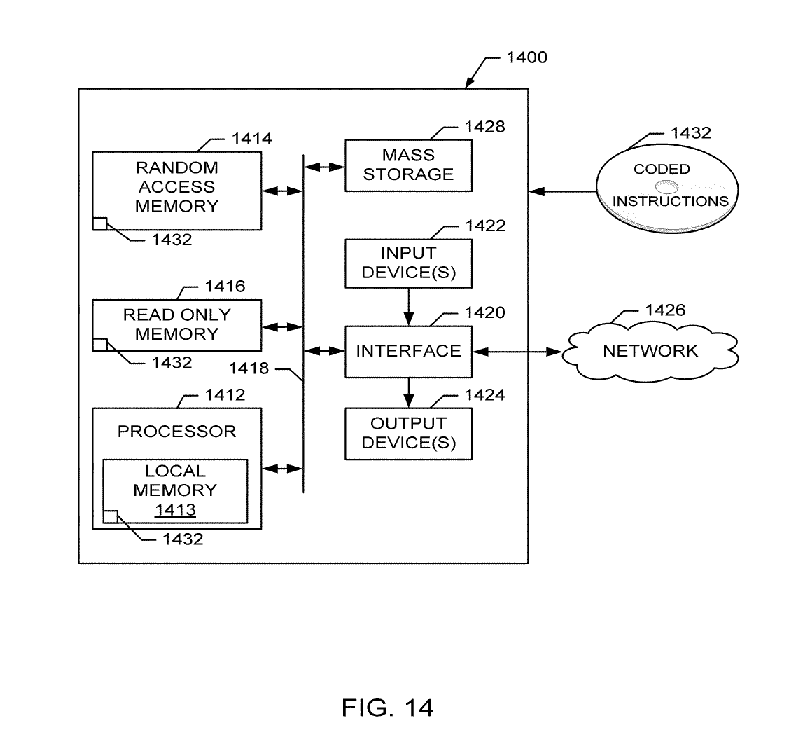

A flowchart representative of example machine readable instructions for implementing the example systems and methods described herein is shown in FIG. 13. In these examples, the machine readable instructions comprise a program for execution by a processor such as the processor 1412 shown in the example processor platform 1400 discussed below in connection with FIG. 14. The program may be embodied in software stored on a tangible computer readable medium such as a compact disc read-only memory (“CD-ROM”), a floppy disk, a hard drive, a digital video disc (DVD), Blu-ray disk, or a memory associated with the processor 1412, but the entire program and/or parts thereof could alternatively be executed by a device other than the processor 1412 and/or embodied in firmware or dedicated hardware. Further, although the example program is described with reference to the flowcharts illustrated in FIG. 13, many other methods of implementing the example systems, etc., may alternatively be used. For example, the order of execution of the blocks may be changed, and/or some of the blocks described may be changed, eliminated, or combined.

As mentioned above, the example processes of FIG. 13 may be implemented using coded instructions (e.g., computer readable instructions) stored on a tangible computer readable medium such as a hard disk drive, a flash memory, a read-only memory (“ROM”), a CD, a DVD, a Blu-Ray, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 13 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 13 illustrates a flow diagram for an example method and associated information flow 1300 for intelligent care transitions. At 1310, a patient 1305 controls goals, preferences, access, and directives. The patient 1305 interacts with one or more dynamic care circles 1315 to facilitate, at 1320, care and care transitions by one or more providers 1325, 1335. At 1330, a care transition occurs between an actor 1325, such as a discharge planner, referring physician, etc., and another actor 1335, such as a care provider. At 1340, the care provider 1335 accepting the care transition may ask about and/or seek clarification regarding the care plan for the patient 1305. The first actor 1325 may be guided in a care plan by one or more guides 1327, such as predictive analytics-based scenario planning to drive more effective discharge plans.

At 1350, the actor(s) 1325 and/or 1335 may provide care circle intelligence to a patient outcome tracker 1345, which can provide decision support based on the data provided and/or other retrieved data compared to care plan, threshold, comparison data, etc. At 1360, the patient outcome tracker triggers one or more alerts to actor(s) 1325 and/or 1335. At 1370, the patient outcome tracker escalates and/or confirms an action, care plan, etc., with the actor 1325.

The patient outcome tracker 1345 can also provide predictive and visual analytics 1355. At 1380, the analytics 1355 can help provide foresight and increased peripheral vision to actor(s) 1325 and/or 1335. At 1390, the analytics 1355 stimulate adherence to a care plan by the patient 1305.

FIG. 14 is a block diagram of an example processor platform 1400 capable of executing instructions of the example systems and methods described herein. The processor platform 1400 can be, for example, a server, a personal computer, an Internet appliance, a set top box, or any other type of computing device.

The processor platform 1400 of the instant example includes a processor 1412. For example, the processor 1412 can be implemented by one or more microprocessors or controllers from any desired family or manufacturer. The processor 1412 includes a local memory 1413 (e.g., a cache) and is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a memory controller.

The processor platform 1400 also includes an interface circuit 1420. The interface circuit 1420 may be implemented by any type of interface standard, such as an Ethernet interface, a universal serial bus (USB), and/or a PCI express interface.

One or more input devices 1422 are connected to the interface circuit 1420. The input device(s) 1422 permit a user to enter data and commands into the processor 1412. The input device(s) can be implemented by, for example, a keyboard, a mouse, a touchscreen, a track-pad, a trackball, isopoint and/or a voice recognition system.

One or more output devices 1424 are also connected to the interface circuit 1420. The output devices 1424 can be implemented, for example, by display devices (e.g., a liquid crystal display, a cathode ray tube display (CRT), etc.). The interface circuit 1420, thus, typically includes a graphics driver card.

The interface circuit 1420 also includes a communication device such as a modem or network interface card to facilitate exchange of data with external computers via a network 1426 (e.g., an Ethernet connection, a digital subscriber line (DSL), a telephone line, coaxial cable, a cellular telephone system, etc.).

The processor platform 1400 also includes one or more mass storage devices 1428 for storing software and data. Examples of such mass storage devices 1428 include floppy disk drives, hard drive disks, compact disk drives and digital versatile disk (DVD) drives. The mass storage device 1428 may implement a local storage device.

The coded instructions 1432 may be stored in the mass storage device 1428, in the volatile memory 1414, in the non-volatile memory 1416, and/or on a removable storage medium such as a CD or DVD.

Although certain example methods, systems, apparatus, and articles of manufacture have been described herein, the scope of coverage of this patent is not limited thereto. On the contrary, this patent covers all methods, systems and articles of manufacture fairly falling within the scope of the claims of this patent.

1. A system comprising:
a processor and a memory to store and execute instructions to provide:
a strategy development and simulation tool to analyze a patient care plan and transitions of care within the care plan to develop and analyze a strategy for the transitions of care within the care plan;
a discharge planning tool including predictive analytics to provide scenario-based planning and visualization to develop the care plan for patient discharge;
visual analytics to track and display progress of the patient against the care plan for the patient; and
an outcome tracker to measure care plan efficacy to provide feedback for the patient care plan and future care plans.

2. The system of claim 1, further comprising a patient-controlled, on-demand social graph of providers and care givers, the graph to enable to patient to communicate with and provide data access to one or more members of the graph.

3. The system of claim 1, wherein the strategy development and simulation tool is to provide information regarding stratification of a patient population and testing of what-if scenarios to aid in development and simulation of care transitions strategies.

4. The system of claim 1, wherein the visual analytics is to provide dynamic, scenario-based visualization.

5. The system of claim 4, wherein the visual analytics is to measure an impact of behavioral economics-based decision making on the care plan and adherence to the care plan.

6. The system of claim 1, wherein the outcome tracker is to provide decision support to help adherence to the care plan for the patient and respond to deviation from the care plan.

7. The system of claim 1, wherein at least one of the strategy development and simulation tool, the discharge planning tool, the visual analytics, and the outcome tracker is to be implemented and provided via a cloud-based platform.

8. A tangible computer-readable storage medium including a set of instructions to be executed by a processor, the instructions, when executed, implementing a system comprising:
a strategy development and simulation tool to analyze a patient care plan and transitions of care within the care plan to develop and analyze a strategy for the transitions of care within the care plan;
a discharge planning tool including predictive analytics to provide scenario-based planning and visualization to develop the care plan for patient discharge;
visual analytics to track and display progress of the patient against the care plan for the patient; and
an outcome tracker to measure care plan efficacy to provide feedback for the patient care plan and future care plans.

9. The computer-readable storage medium of claim 8, further comprising a patient-controlled, on-demand social graph of providers and care givers, the graph to enable to patient to communicate with and provide data access to one or more members of the graph.

10. The computer-readable storage medium of claim 8, wherein the strategy development and simulation tool is to provide information regarding stratification of a patient population and testing of what-if scenarios to aid in development and simulation of care transitions strategies.

11. The computer-readable storage medium of claim 8, wherein the visual analytics is to provide dynamic, scenario-based visualization.

12. The computer-readable storage medium of claim 11, wherein the visual analytics is to measure an impact of behavioral economics-based decision making on the care plan and adherence to the care plan.

13. The computer-readable storage medium of claim 8, wherein the outcome tracker is to provide decision support to help adherence to the care plan for the patient and respond to deviation from the care plan.

14. The computer-readable storage medium of claim 8, wherein at least one of the strategy development and simulation tool, the discharge planning tool, the visual analytics, and the outcome tracker is to be implemented and provided via a cloud-based platform.

15. A method comprising:
analyzing, using a processor, a patient care plan and transitions of care within the care plan to develop and analyze a strategy for the transitions of care within the care plan;
providing scenario-based planning and visualization using predictive analytics to develop the care plan for patient discharge;
tracking and displaying progress of the patient against the care plan for the patient using visual analytics; and
measuring care plan efficacy using an outcome tracker to provide feedback for the patient care plan and future care plans.

16. The method of claim 15, further comprising providing a patient-controlled, on-demand social graph of providers and care givers, the graph to enable to patient to communicate with and provide data access to one or more members of the graph.

17. The method of claim 15, further comprising testing of what-if scenarios to aid in development and simulation of care transitions strategies.

18. The method of claim 15, wherein the visual analytics comprises measuring an impact of behavioral economics-based decision making on the care plan and adherence to the care plan.

19. The method of claim 15, further comprising providing decision support to help adherence to the care plan for the patient and respond to deviation from the care plan.

20. The method of claim 15, further comprising providing at least a portion of the method via a cloud-based platform.
